(19) United States
(12) Patent Application Publication
(10) Pub. No.: US 2025/0304493 A1
(43) Pub. Date: Oct. 2, 2025

(54) FIBER ASSEMBLY, HEAT INSULATION MATERIAL, AND METHOD OF PRODUCING FIBER ASSEMBLY

(71) Applicant: CANON KABUSHIKI KAISHA, Tokyo (JP)

(72) Inventors: KYOHEI ISHIKAWA, Saitama (JP); JUNZO KOBAYASHI, Tochigi (JP)

(21) Appl. No.: 19/088,786

(22) Filed: Mar. 24, 2025

(30) Foreign Application Priority Data
Mar. 26, 2024 (JP) 2024-050585

(51) Int. Cl. C03C 25/1095

(52) U.S. Cl. CPC C03C 25/1095; C03C 2213/00; C03C 2217/21; C03C 2217/281; C03C 2217/76; C03C 2217/77; C03C 2218/1525

(57) ABSTRACT

A fiber assembly according to the present disclosure includes a fiber, and a coating layer that contains an oxide or a nitride covering a surface of the fiber, in which a carbon content in a surface layer of the coating layer is greater than a carbon content inside the coating layer, the fiber assembly is formed by intertwining of the fiber, and the inside or the surface layer of the coating layer contains a hydrocarbon group.

### BACKGROUND

### Field of the Disclosure

The present disclosure relates to a fiber assembly, a heat insulation material, and a method of producing a fiber assembly.

### Description of the Related Art

A fiber assembly (also referred to as a cotton-like fiber or a cotton-like body) typically formed such that fibers, such as cotton, are intertwined and spaces are present in the gaps between the fibers has excellent functions such as heat insulation performance. Therefore, the fiber assembly is used in a wide variety of products, such as heat insulation materials for building materials such as houses, heat insulation materials for industrial products such as electric furnaces, warming containers, down jackets, and feather quilts. However, while the fiber assembly exhibits excellent heat insulation performance, the fiber assembly has a property of easily adsorbing moisture due to a capillary phenomenon. Accordingly, in a case where a fiber assembly, such as glass wool (also known as fiber glass), is used as a heat insulation material for a building material, a temperature difference between the inside and the outside of a building is considered to cause condensation inside walls due to the dampness, and thus glass wool adsorbs the condensed moisture and dampness. For this reason, there is a concern that malfunctions, such as a shift of the heat insulation material from the fixed portion, may occur along with mold growth, corrosion inside the walls, and a weight increase due to the moisture adsorption.

It is considered that such a fiber assembly is prevented from adsorbing moisture by allowing the fibers to have waterproof properties. Japanese Patent Laid-Open No. 2002-121082 discloses a technique of performing a water-repellent treatment by forming a film on a surface of a fiber with gold (Au), platinum (Pt), or yttria (Y₂O₃) using a physical vapor deposition method.

However, the technique disclosed in Japanese Patent Laid-Open No. 2002-121082 has a problem of durability, and thus there is a possibility that the waterproof properties cannot be ensured for a long period of time.

### SUMMARY OF THE DISCLOSURE

The present disclosure provides a fiber assembly including: a fiber; and a coating layer that contains an oxide or a nitride covering a surface of the fiber, in which a carbon content in a surface layer of the coating layer is greater than a carbon content inside the coating layer, the fiber assembly is formed by intertwining of the fiber, and the inside or the surface layer of the coating layer contains a hydrocarbon group.

Further features of the present disclosure will become apparent from the following description of exemplary embodiments with reference to the attached drawings.

### BRIEF DESCRIPTION OF THE DRAWINGS

FIG. 1 is a schematic view showing a heat insulation structure to which a fiber assembly according to the present disclosure can be applied.

FIG. 2 is a schematic view showing the fiber assembly according to the present disclosure.

FIG. 3 is a cross-sectional view showing a fiber constituting the fiber assembly.

FIG. 4 shows an example of a film forming device that coats a fiber with a coating layer.

FIG. 5 shows another example of a film forming device that coats a fiber with a coating layer.

FIGS. 6A and 6B are graphs showing thermal desorption of a carbon component contained in a coating layer of Example 1.

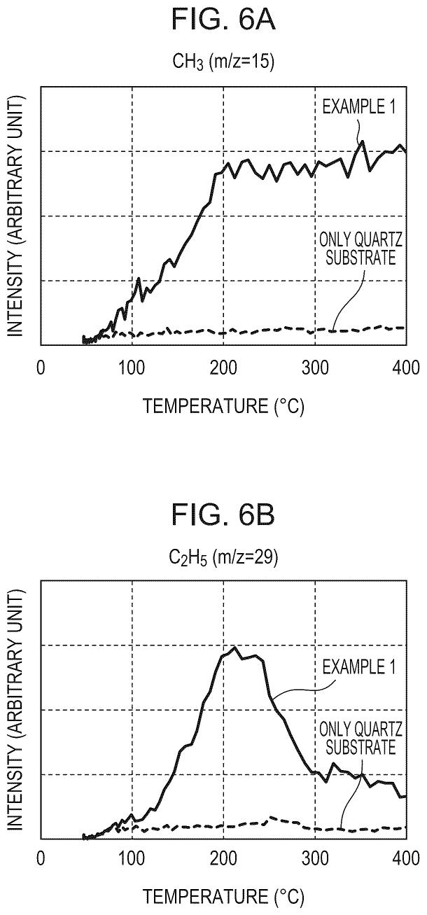

### DESCRIPTION OF THE EMBODIMENTS

Hereinafter, embodiments of the present disclosure will be described in detail with reference to the accompanying drawings. Further, in the drawings referred to in the following description of the embodiments and examples, elements denoted by the same reference numerals have the same functions unless otherwise specified.

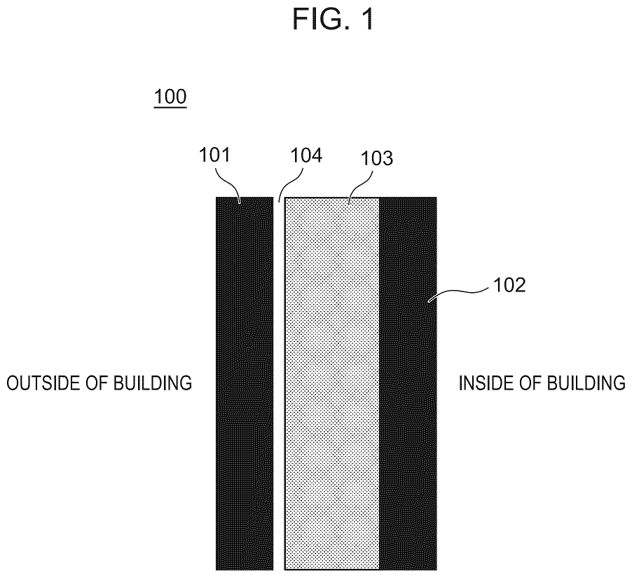

FIG. 1 is a schematic view showing a heat insulation structure of a building to which a fiber assembly 200 according to the present disclosure can be applied. The heat insulation structure of a building includes, for example, an outer wall 101, an inner wall 102, a heat insulation material 103, and a vent hole 104. A building typically has a heat insulation structure to prevent the temperature outside the building from being transmitted to the inside of the building. The fiber assembly 200 according to the present disclosure can be employed as the heat insulation material 103 used in the heat insulation structure. The fiber assembly 200 used in such a heat insulation material 103 is required to be a fiber assembly 200 having excellent heat insulation properties, excellent waterproof properties to prevent moisture adsorption, and excellent durability to withstand long-term use.

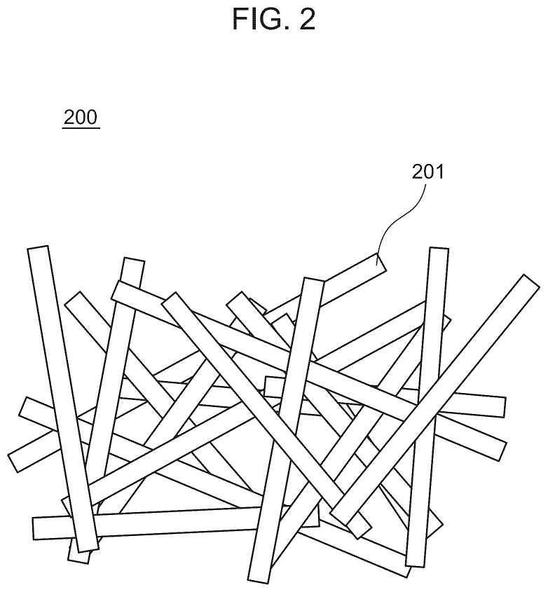

FIG. 2 is a schematic view showing the fiber assembly 200 according to the present embodiment. The fiber assembly 200 (also referred to as a cotton-like body) is formed such that fibers, such as the fiber material 201, are intertwined in the form of cotton, and is provided with spaces present in the gaps between the fibers. Further, the fiber assembly 200 may have crimp properties such as a wavy or spiral crimp in the fibers. The fiber assembly 200 can be applied not only to heat insulation materials for industrial products such as the heat insulation material 103, but also to a wide variety of products such as warming containers, down jackets, and feather quilts.

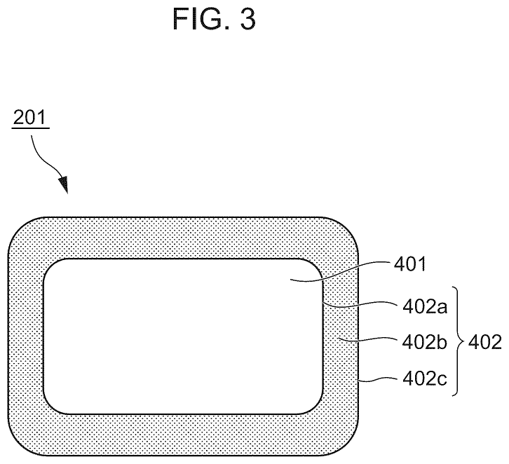

FIG. 3 is a cross-sectional view showing such a fiber material 201. The fiber material 201 is formed of a fiber 401 and a coating layer 402 that covers the periphery of the fiber 401. A chemical fiber such as glass wool (which name is interchangeable with fiber glass), rock wool, or polyester, a natural fiber such as silk or cotton, an animal fiber such as wool, or the like can be employed as the fiber 401. Further, in a case of the fiber material 201 used as the heat insulation material shown in FIG. 1, the heat insulation properties can be further ensured by employing glass wool having a fine structure at a micron level.

The coating layer 402 is a layer including an oxide film or a nitride film on the surface of the fiber 401. The oxide film is a film containing an oxide as a main component, and also contains impurities such as carbon and hydrogen. The same applies to the nitride film, and the nitride film also contains impurities such as carbon and hydrogen.

Examples of the material used in the oxide film include yttrium oxide (Y₂O₃), silicon oxide (SiO₂), aluminum oxide (Al₂O₃), tantalum oxide (Ta₂O₅), titanium oxide (TiO₂), niobium oxide (Nb₂O₅), and zirconium oxide (ZrO₂), but the present disclosure is not limited thereto. Further, a mixture of these materials may be used. Examples of the material used in the nitride film include silicon nitride (SiN), titanium nitride (TiN), and aluminum nitride (AlN), but the present disclosure is not limited thereto.

Further, the material used in the coating layer 402 may have a low interaction with water. Specifically, the metal element can include one or more transition metals and/or one or more rare earth metals.

Further, the film thickness of the coating layer 402 is not particularly limited as long as the following performance can be ensured, but can be about 5 nm to several hundreds of nm. In addition, the coating layer 402 is not necessarily a single layer film, and may be a multilayer film formed by laminating a plurality of layers.

Further, the coating layer 402 is formed of a surface layer 402a which is a surface exposed to the atmosphere, an inner portion 402b, and an interface 402c which is a portion in contact with the fiber 401. Further, the coating layer 402 is formed such that the carbon content in the surface layer 402a is set to be greater than the carbon content in the inner portion 402b or the interface 402c. When the coating layer 402 is formed in this manner, the proportion of a functional group such as an alkyl group or a methylene group to be exposed on the surface of the surface layer 402a of the coating layer 402 can be increased. In a case where the functional group such as an alkyl group is exposed on the surface thereof, the surface free energy can be further decreased as compared with a case where the functional group is not exposed on the surface thereof. That is, the contact angle of the surface of the coating layer 402 with water can be increased, and the resistance to water can be improved. The chemical species to be bonded to the carbon in the surface layer 402a of the coating layer 402 is not particularly limited, but the carbon may be bonded to, for example, a carbon atom, a hydrogen atom, or an oxygen atom. Specifically, in terms of the water resistance, the coating layer may have water resistance to an extent that the original cotton shape can be maintained substantially without the fiber material 201 adsorbing moisture even when the fiber material 201 is allowed to stand for 100 hours or longer in an environmental tester set at a temperature of 60° C. and a humidity of 80%.

In a case where the carbon content in the surface layer 402a of the coating layer 402 is defined as [Cₛ] and the oxygen content or the nitrogen content therein is defined as [Bₛ], an expression of [Cₛ]/[Bₛ]≥0.5 can be satisfied within a range of 5 nm from the surface in the thickness direction. When the surface layer is formed in the above-described manner, the functional group is sufficiently exposed on the surface so that the contact angle is increased, and thus the resistance to water can be further improved.

Further, in a case where the carbon content in the inner portion 402b of the coating layer 402 is defined as [Cₙ] and the oxygen content or the nitrogen content therein is defined as [Bₙ], an expression of [Cₙ]/[Bₙ]≤1.6 can be satisfied in a range of greater than 5 nm from the surface in the thickness direction. The permeation of water vapor can be suppressed by suppressing an increase in the carbon content in the oxide film or the nitride film, and thus the resistance to water can be further improved.

Further, the coating layer 402 according to the present embodiment may has low moisture permeation properties. Specifically, in a case where film formation is performed on a flat plate-like substrate formed of a PET resin with a thickness of 25 μm, the amount of water vapor that permeates through the film per square meter of an area for 24 hours by a water vapor permeability measurement test defined in JIS K 7219, that is, the moisture permeability can be 30 g/(m²·day) or less.

Further, the coating layer 402 according to the present embodiment may have high water repellency. Specifically, in a case where the coating layer 402 including an oxide film or a nitride film is formed on a flat plate-like quartz substrate with a thickness of 1 mm, the contact angle measured when liquid droplets of water have landed by a static drop method defined in JIS R 3257:1999 can be 100° or greater.

Further, the coating layer 402 of the present embodiment may have a structure in which cracks are unlikely to occur in the layer in order to ensure the long-term durability. Specifically, the coating layer 402 can be formed of an amorphous material.

### Film Formation Method for Coating Layer

The coating layer 402 can be formed, for example, using an atomic layer deposition method (hereinafter, also referred to as an ALD method) as disclosed in PCT Japanese Translation Patent Publication No. 2009-525406, a sputtering method, or a vacuum deposition method. In the ALD method, since the film formation proceeds by adsorption of a monomolecular layer, a film can be formed with a uniform film thickness without being affected by the shape of the substrate. Therefore, the ALD method can be said to be a suitable method as a method of forming a film on the fiber 401 constituting the fiber assembly 200. The coating layer 402 is formed along the shape of the fiber 401 of the fiber assembly 200. Since a dense film is formed due to film formation carried out by forming monomolecular layers one by one, gas barrier properties are high, and thus permeation of gas including water vapor can be suppressed. Further, the coating layer 402 is formed to cover the entire fiber 401, and thus the water resistance can be ensured for the entire fiber assembly 200.

Hereinafter, the ALD method will be briefly described. The ALD method is a film formation method that is typically performed in a vacuum, and a film can be formed by repeatedly performing four steps (one cycle) of a step of introducing an organometallic gas referred to as a precursor, a step of purging the organometallic gas, a step of introducing a reactive gas, and a step of purging the reactive gas.

Next, a film formation method for forming a film on each of the fibers 401 of the fiber assembly 200 by the ALD method using yttrium oxide (Y₂O₃) as the material of the coating layer 402 will be described in detail. Tris(butylcyclopentadienyl)yttrium(III) (manufactured by Sigma-Aldrich) is used as a precursor, and H₂O is used as a reactive gas (oxidizing agent). Further, the precursor and the reactive gas can be appropriately changed according to the target material. For example, tetrakis(ethylmethylamino) zirconium or the like may be used as the precursor in a case of film formation with zirconium oxide (ZrO₂), and trimethylaluminum or the like may be used as the precursor in a case of film formation with aluminum oxide (Al₂O₃). Further, as the gas used as the reactive gas, O₃, H₂O₂, or the like may be used in addition to H₂O in a case where the target is an oxide film, and NH₃ or the like may be used as the target is a nitride film. In addition, film formation is performed using Ar gas, which is an inert gas, for the purpose of efficiently introducing a raw material gas and for the purpose of efficiently exhausting the gas in the purging step.

The temperature of a reaction chamber is set to 120° C., and the pressure thereof is set to 100 Pa. Further, the precursor supply time per cycle is set to 5 s, the oxidizing agent supply time per cycle is set to 0.5 s, and the purge time per cycle is set to 30 s. In a case where film formation is performed under the conditions described in the present embodiment, since the thickness of the film grown per cycle is about 0.08 nm, a film having a thickness of about 100 nm is formed by repeating a total of 1200 cycles. Further, only in the last 1200th cycle, the step of introducing an oxidizing agent is excluded, and film formation is performed such that a surface portion of the prepared film is covered with a precursor, that is, the carbon content in the surface portion is greater than the carbon content in a portion inside the film. The production conditions described here are merely an example, and the present disclosure is not limited thereto. For example, film formation may be performed by changing the gas material, changing the time for which the gas is introduced, changing the temperature, or changing the film thickness or film formation may be performed by using plasma in order to promote the reaction. Further, a laminated film or a mixed film may be formed by introducing a plurality of precursors or a plurality of reactive gases.

Further, all the fibers 401 constituting the fiber assembly 200 can be coated with the coating layer 402. However, in a case where it is considered that the water resistance or the durability is not significantly affected, an area where some of the fibers 201 in a central portion of the fiber assembly 200 are not coated with the coating layer 402 may be present.

### Film Forming Device for Coating Layer

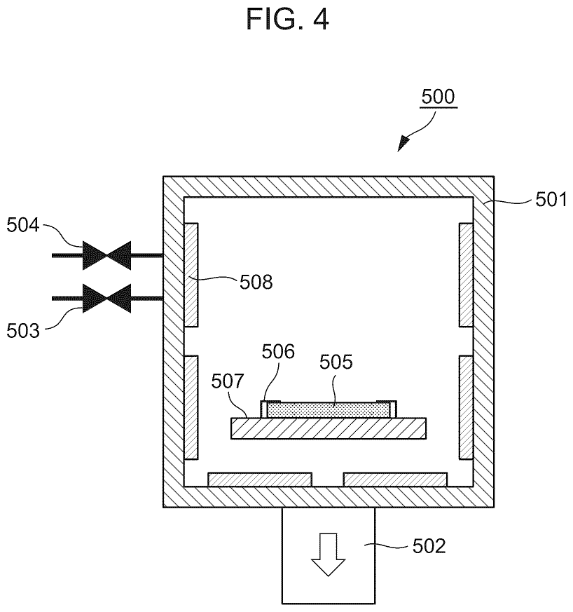

FIG. 4 shows an example of a film forming device that coats the fiber 401 of the fiber assembly 200 with the coating layer 402 using the ALD method. A film forming device 500 includes a reaction chamber 501, an exhaust pump 502, an introduction port 503 for a precursor and an inert gas, an introduction port 504 for a reactive gas (oxidation reaction), and a heating mechanism 508, and the reaction chamber 501 includes a substrate holding mechanism 507. A substrate 505 is placed on the substrate holding mechanism 507. In a case where the substrate 505 is a lightweight material such as the fiber assembly 200 as in the present embodiment, the substrate 505 may be held in place by a substrate fixing jig 506 such that the substrate 505 is not separated from the substrate holding mechanism 507 during evacuation. The coating layer 402 can be provided on each of the fibers 401 constituting the fiber assembly 200 by holding the fiber assembly 200 prepared in the substrate holding mechanism 507 in the above-described manner and performing a film formation treatment of the coating layer 402 on the fibers 401 of the fiber assembly 200.

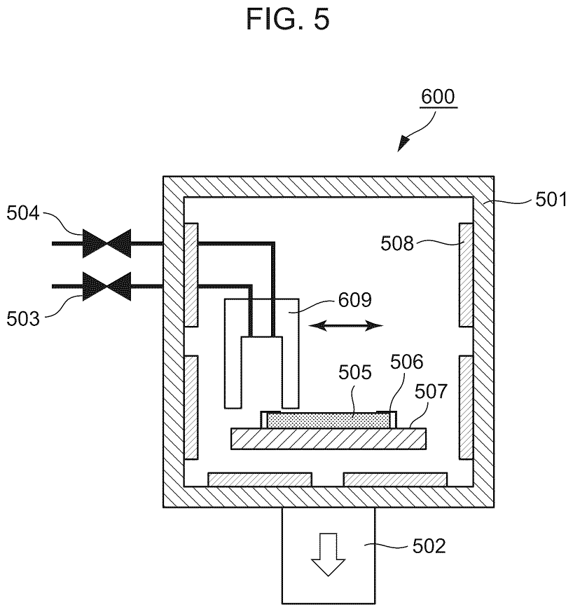

FIG. 5 shows another example of a film forming device that coats the fiber 401 of the fiber assembly 200 with the coating layer 402 using the ALD method. The device structure of a film forming device 600 is the same as the device structure of the film forming device 500. The film forming device 600 particularly includes a movable gas supply mechanism 609. In this manner, when the pressure of gas is locally increased, the growth rate of the film is increased or the gas is likely to penetrate to the inside of the substrate even in the substrate having gaps in the thickness direction of the fibers or the like so that a more uniform film can be formed even to the fibers inside the substrate. A flexible and expandable pipe or the like may be used as the gas pipe inside the reaction chamber of the gas supply mechanism 609.

### Evaluations of Examples and Comparative Examples

Next, an example of a fiber assembly 200 formed using the present disclosure and comparative examples thereof will be described.

In addition, these configurations are merely examples, and the present disclosure is not limited thereto. Further, the configurations and the film formation methods can be changed as appropriate. The results of the example and each comparative example were observed and evaluated. The evaluation methods are as follows.

### Observation and Evaluation of Constituent Elements

The surface of the fiber assembly 200 was observed using a scanning electron microscope (SEM). Thereafter, the film was subjected to elemental analysis by performing elemental analysis on a specific site in a field of view using energy dispersive X-ray spectroscopy (EDX method). A cross section of the fiber assembly 200 was observed by cutting out a cross section of the fiber 401 of the fiber assembly 200 and observing the cross section with a transmission electron microscope (TEM), and the elemental analysis of the film was performed on a specific site in a field of view using the EDX method.

The composition of the coating layer 402 and the bonding state were evaluated by performing analysis using X-ray photoelectron spectroscopy (XPS method). The escape depth of photoelectrons in the XPS method is about several Å to several nm, and thus the top surface of the coating layer 402 can be subjected to composition analysis. Further, not only the surface portion but also the inside of the film can also be analyzed using an Ar ion or C60 ion gun. The composition ratio between the carbon content and the oxygen content and/or the nitrogen content in the surface portion and the inside of the prepared film can be determined by using the method described above.

### Evaluation of Water Vapor Permeation Properties

The water vapor permeation properties of the fiber assembly 200 were evaluated by performing a water vapor permeability measurement (moisture permeability measurement) test defined in JIS K 7219 using a gas chromatography method.

### Evaluation of Contact Angle

The contact angle of the fiber assembly 200 was evaluated by the static drop method defined in JIS R 3257:1999. The contact angle can be measured based on the results of liquid droplets of water having landed on the surface of the coating layer by the test.

### Evaluation of Adhesiveness

The adhesiveness of the fiber assembly 200 was evaluated by a tape peeling test. The adhesiveness between samples can be compared by standardizing the material of tape, the pulling speed, and the pulling direction.

### Evaluation of Crystallinity

The crystallinity of the fiber assembly 200 can be analyzed by X-ray diffraction analysis (XRD method). In a case where the film according to the present disclosure is evaluated, when the film to be measured is irradiated with X-rays at a small incidence angle of about 0.5° to observe the diffraction pattern, whether or not the film is amorphous can be evaluated when a clear diffraction peak is not detected, that is, a halo pattern is observed.

### Environmental Test

An environmental test was performed by allowing the fiber assembly 200 to stand for 100 hours in an environmental tester set at a temperature of 60° C. and a humidity of 80%, and a change in appearance before and after the test was evaluated.

### Example 1

In Example 1, the coating layer 402 of yttrium oxide (Y₂O₃) was formed with a thickness of 100 nm on the fiber 401 constituting the fiber assembly 200 by repeatedly performing the ALD method using the film forming device as shown in FIG. 5 for 1200 cycles. In this case, only in the final one cycle of the ALD method, the film formation was performed without carrying out an oxidation step by introducing a reactive gas.

Glass wool (feather glass, manufactured by PARAMOUNT GLASS MFG Co., Ltd.) was used as the fiber 401.

Feather glass with a density of 32 kg/m³ was used. The length of the fiber constituting the feather glass used in Example 1 was about 1 to 100 μm, and the diameter (thickness) of the fiber was about 1 to 10 μm. Further, the gap size between the fibers, that is, the pore size is not uniquely determined due to the irregular structure, but is, for example, about several μm to several hundreds of μm. In a case where each film was evaluated, a substrate in the form suitable for the evaluation was selected by changing the substrate to flat plate-like glass or a flat plate-like PET resin. Specifically, a flat plate-like quartz substrate with a thickness of 1 mm was selected for the evaluation of the film composition and the bonding state, the evaluation of the contact angle, the evaluation of the adhesiveness, and the evaluation of the crystallinity, and a flat plate-like PET resin substrate with a thickness of 25 μm was selected for the evaluation of the water vapor permeation properties.

When the fiber assembly 200 prepared in Example 1 was allowed to stand for 100 hours in an environmental tester set at a temperature of 60° C. and a humidity of 80%, a result in which the fiber assembly 200 was in a satisfactory state that had been maintained without adsorbing moisture and without crushing the cotton shape was obtained.

When a cross section of the fiber assembly 200 prepared in Example 1 was cut out and observed with a TEM, and elemental analysis of the film was performed on a specific site in a field of view using the EDX method, a result in which the film of the coating layer was adhered to the fibers 201 in the central portion of the fiber assembly 200 was obtained.

Various analysis and evaluations were performed on the film prepared in Example 1. The composition inside the Y₂O₃ film (specifically, in a range greater than 5 nm from the surface of the film in the thickness direction) was evaluated using the XPS method. Here, when the content of yttrium [Y] at %, oxygen [O] at %, and carbon [C] at % was set to 100 at %, the content of [Y] was 37.6 at %, the content of [O] was 56.5 at %, and the content of [C] was 5.9 at %. That is, the carbon content was about 0.1 times the oxygen content. Meanwhile, the composition of the surface layer (specifically, within a range of 5 nm from the surface of the film in the thickness direction) was 9.5 at % of [Y], 13.6 at % of [O], and 76.9 at % of [C]. That is, the carbon content was about 5.8 times the oxygen content. Further, when the bonding state of carbon in the surface layer was analyzed, a result in which 90% or greater of carbon was bonded to hydrogen and several percentages of the remaining carbon was bonded to oxygen or carbon was obtained. The water repellency angle evaluated by the static drop method was 101.5°, and the moisture permeability evaluated by the water vapor permeability measurement test was 22 g/(m²·day), both of which showed satisfactory results. Further, since the moisture permeability of the PET resin substrate with a thickness of 25 μm was 50 g/(m²·day), the effect of preventing moisture permeation into the film prepared in Example 1 was considered to be sufficiently obtained. Further, it was confirmed that the film was amorphous in the evaluation of crystallinity using the XRD method, and noticeable peeling of the film did not occur even in the evaluation of adhesiveness by the tape peeling test, both of which showed satisfactory results.

### Comparative Example 1

In Comparative Example 1, a coating layer of yttrium oxide (Y₂O₃) was formed with a thickness of 100 nm on the fiber 401 constituting the fiber assembly 200 using a method different from the method according to the present embodiment in which [Cₛ]/[Bₛ]<0.5 is satisfied. Specifically, film formation was performed while oxygen gas was circulated such that the pressure of a film forming chamber reached 10-2 Pa using yttrium oxide as a vapor deposition source. In Comparative Example 1, elements other than yttrium and oxygen were not used during the film formation. Further, the same glass wool as in Example 1 was used as the fiber 401. In addition, in a case where each film was evaluated in the same manner as in Example 1, a substrate in the form suitable for the evaluation was selected by changing the substrate to flat plate-like glass or a flat plate-like PET resin.

When the fiber 401 prepared in Comparative Example 1 was allowed to stand for 100 hours in an environmental tester set at a temperature of 60° C. and a humidity of 80%, a result in which the fiber assembly 200 adsorbed moisture and thus the cotton shape was crushed was obtained.

When a cross section of the fiber assembly 200 prepared in Comparative Example 1 was cut out and observed with a TEM, and elemental analysis of the film was performed on a specific site in a field of view using the EDX method, a result in which adhesion of the film to the central portion of the fiber assembly 200 was not found was obtained.

Various analysis and evaluations of the film were performed on the coating layer prepared in Comparative Example 1. The composition inside the Y₂O₃ film (specifically, in a range greater than 5 nm from the surface of the film in the thickness direction) prepared in Comparative Example 1 was 38.5 at % of [Y], 60.3 at % of [O], and 1.20 at % of [C]. That is, the carbon content was about 0.02 times the oxygen content. Meanwhile, the composition of the surface layer (specifically, within a range of 5 nm from the surface of the film in the thickness direction) was 37.5 at % of [Y], 57.1 at % of [O], and 5.4 at % of [C]. That is, the carbon content ([C]/[O]) was about 0.08 times the oxygen content. Further, the water repellency angle evaluated by the static drop method was about 60°, and the moisture permeability evaluated by the water vapor permeability measurement test was 45 g/(m²·day), both of which showed unsatisfactory results in terms of waterproof performance. Further, it was found that the film was crystalline in the evaluation of crystallinity using the XRD method and confirmed that cracks occurred when the surface of the film was confirmed with an SEM. In addition, satisfactory results were obtained in the evaluation of adhesiveness by the tape peeling test.

### Comparative Example 2

In Comparative Example 2, the fiber 401 constituting the fiber assembly 200 was coated with a coating layer of a silicon water repellent agent (KF-96-SP, manufactured by Shin-Etsu Chemical Co., Ltd.) using a method different from the method of the present embodiment in which [Cₛ]/[Bₛ]≥1.6 is satisfied. Specifically, in the present comparative example, the fiber 401 was spray-coated with the coating layer. The film thickness was set to about 5 μm. Further, the same glass wool as in Example 1 was used as the fiber 401. In addition, in a case where each film was evaluated in the same manner as in Example 1, a substrate in the form suitable for the evaluation was selected by changing the substrate to flat plate-like glass or a flat plate-like PET resin.

When the fiber 401 prepared in Comparative Example 2 was allowed to stand for 100 hours in an environmental tester set at a temperature of 60° C. and a humidity of 80%, a result in which the fiber 401 adsorbed moisture and thus the cotton shape was crushed was obtained.

When a cross section of the fiber assembly 200 prepared in Comparative Example 2 was cut out and observed with a TEM, and elemental analysis of the film was performed on a specific site in a field of view using the EDX method, a result in which adhesion of the film to the central portion of the fiber assembly 200 was not found was obtained.

Various analysis and evaluations of the film were performed on the coating layer prepared in Comparative Example 2. The composition inside the silicon film (specifically, in a range greater than 5 nm from the surface of the film in the thickness direction) prepared in Comparative Example 2 was 19.3 at % of [Si], 27.5 at % of [O], and 53.2 at % of [C]. That is, the carbon content was about 1.9 times the oxygen content. Meanwhile, the composition of the surface portion (specifically, within a range of 5 nm from the surface of the film in the thickness direction) was 12.5 at % of [Si], 15.2 at % of [O], and 72.3 at % of [C]. That is, the carbon content ([C]/[O]) was about 2.0 times the oxygen content. Further, the water repellency angle evaluated by the static drop method was 110°, which was a satisfactory result. Meanwhile, the moisture permeability evaluated by the water vapor permeability measurement test was 51 g/(m²·day), which was a result almost the same as in the case of the PET resin substrate. That is, the film prepared in Comparative Example 2 is considered to have no effect of preventing moisture permeation. Further, it was confirmed that the film was amorphous in the evaluation of crystallinity using the XRD method, but a result in which peeling of the film occurred in the evaluation of adhesiveness evaluated by the tape peeling test was obtained.

Table 1 lists the configuration of the fiber assembly 200, the film formation method, the ratio of the carbon content to the oxygen content ([C]/[O]) inside the film and in the surface portion thereof, and the result of the water repellency, the moisture permeation properties, the crystallinity, and the adhesiveness in the example and the comparative examples described above. Further, the film prepared in the present embodiment is assumed to also contain hydrogen based on the results of analysis of the carbon bonding state using the XPS method, but the photoelectron spectrum of hydrogen cannot be detected by the XPS method, and thus whether or not the film contained hydrogen is not listed in Table 1.

TABLE 1

| | | | | | Moisture | | |
|---|---|---|---|---|---|---|---|
| | | | | | permeation | | |
| | | | | | prevention | | |
| | | | Surface | Waterproof | properties | | |
| | | Inside | portion of | properties | Moisture | | |
| | Configuration | of layer | layer | Contact | permeability ≤30 | | |
| | Fiber/coating layer | [C]/[O] | [C]/[O] | angle ≥100° | g/(m² · day) | Crystallinity | Adhesiveness |
| Example 1 | Glass wool/Y₂O₃ | 0.1 | 5.8 | OK | OK | Amorphous | OK |
| | (carbon content in | | | | | | |
| | surface portion was | | | | | | |
| | greater) | | | | | | |
| Comparative | Glass wool/Y₂O₃ | 0.02 | 0.08 | NG | NG | Crystalline | OK |
| Example 1 | | | | | | | |
| Comparative | Glass wool/silicon | 1.93 | 4.7 | OK | NG | Amorphous | NG |
| Example 2 | water repellent | | | | | | |
| | agent | | | | | | |

Based on the results listed in Table 1, the conditions for obtaining the fiber assembly 200 having excellent waterproof properties, such as water repellency and moisture permeation prevention properties, and excellent durability that enables prevention of occurrence of cracks and film peeling even in long-term use will be described.

The water repellency was determined by the carbon content in the surface layer of the coating layer 402. The ratio of the carbon content to the oxygen content within a range of 5 nm from the surface of the coating layer in the thickness direction can be [C]/[O]≥0.5 or [C]/[O]≥4.0. A high carbon content is considered to indicate high water repellency, that is, a high contact angle. The reason for this is assumed that most of the carbon components analyzed by the XPS method described in Example 1 were bonded to hydrogen, and the hydrocarbon group was exposed on the surface portion so that the surface free energy was decreased, and thus the contact angle was increased. Further, the carbon element contained in the coating layer of Example 1 is considered to be mainly derived from a precursor. Therefore, when the carbon components in the Y₂O₃ film prepared on flat plate glass by the method described in the present embodiment were actually analyzed by thermal desorption spectrometry, a result in which desorption of hydrocarbon groups, such as a CH₃ component (m/z=15) and a C₂H₅ component (m/z=29), was observed was obtained.

The moisture permeation prevention properties are determined by the carbon content inside the coating layer and the crystallinity of the coating layer (presence or absence of cracks). The ratio of the carbon content to the oxygen content in a range of greater than 5 nm from the surface of the coating layer in the thickness direction can be [C]/[O]≤1.6 or [C]/[O]≤0.5. The coating layer can be amorphous in terms of the crystallinity. The reason why a decrease in the carbon content improves the effect of preventing moisture permeation is not clear. However, it is assumed that when impurity components such as carbon are mixed into the oxide film or the nitride film originally having excellent moisture permeation prevention properties, the film density is decreased, and the gaps inside the film structure are increased, that is, the diffusion coefficient is increased, and thus the effect of preventing moisture permeation cannot be obtained. In addition, the reason why the effect of preventing moisture permeation cannot be sufficiently obtained despite the small carbon content of Comparative Example 1 is assumed to be the occurrence of cracks due to the crystalline film and the penetration of moisture through the cracks in the film. Further, the result in which the film of the coating layer was not adhered to the central portion of the fiber assembly 200 in Comparative Example 1 is assumed to be one of the reasons why the effect of preventing moisture permeation was not obtained.

The adhesiveness is determined by the carbon content inside the coating layer. The ratio of the carbon content to the oxygen content in a range of greater than 5 nm from the surface of the coating layer in the thickness direction can be [C]/[O]≤1.6 or [C]/[O]≤ 0.5. The adhesiveness is assumed to be related to the manner of bonding the substrate and the film or the manner of adsorption. Specifically, a metal oxide film containing a small amount of carbon was mainly deposited on the substrate in a case of Example 1 and Comparative Example 1, whereas an organic film containing carbon as a main component was mainly deposited on the substrate in a case of Comparative Example 2. Bonds which are ionic bonds and covalent bonds, that is, bonds due to chemical adsorption were predominant in the case of Example 1 and comparative Example 1, whereas van der Waals bonds, that is, bonds due to physical adsorption were predominant in the case of Comparative Example 2. It is assumed that since the van der Waals bonds are bonded by an intermolecular force as compared with the ionic bonds or the covalent bonds, the bonding strength is low, the film is easily peeled off even in a case where a small external force is applied, and thus the adhesive force cannot be sufficiently obtained in Comparative Example 2.

With the configuration as described above, it is possible to provide a fiber assembly with excellent waterproof properties and excellent durability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-050585, filed Mar. 26, 2024, which is hereby incorporated by reference herein in its entirety.

What is claimed is:

1. A fiber assembly comprising:
a fiber; and
a coating layer that comprises an oxide or a nitride covering a surface of the fiber,
wherein a carbon content in a surface layer of the coating layer is greater than a carbon content inside the coating layer,
the fiber assembly is formed by intertwining of the fiber, and
the inside or the surface layer of the coating layer contains a hydrocarbon group.

2. The fiber assembly according to claim 1,
wherein in a case where the carbon content in the surface layer of the coating layer is defined as [Cₛ] and an oxygen content or a nitrogen content in the surface layer is defined as [Bₛ], an expression of [Cₛ]/[Bₛ]≥0.5 is satisfied.

3. The fiber assembly according to claim 1,
wherein in a case where the carbon content inside the coating layer is defined as [Cₙ] and an oxygen content or a nitrogen content inside the coating layer is defined as [Bₙ], an expression of [Cₙ]/[Bₙ]≤1.6 is satisfied.

4. The fiber assembly according to claim 1, wherein the coating layer is amorphous.

5. The fiber assembly according to claim 1, wherein the coating layer contains a transition metal.

6. The fiber assembly according to claim 1, wherein the coating layer contains a rare earth metal.

7. The fiber assembly according to claim 1, wherein the fiber assembly has crimp properties.

8. A heat insulation material which is formed of the fiber assembly according to claim 1, wherein the fiber is glass wool.

9. A method of producing a fiber assembly, comprising:
preparing a fiber assembly formed by intertwining of a fiber; and
forming a coating layer containing an oxide or a nitride on a surface of the fiber of the fiber assembly,
wherein the forming of the coating layer is performed such that a carbon content in a surface layer of the coating layer is greater than a carbon content inside the coating layer.

10. The production method according to claim 9, wherein the forming of the coating layer is performed by using an atomic layer deposition method.
